(19) United States
(12) Patent Application Publication
(10) Pub. No.: US 2010/0315209 A1
(43) Pub. Date: Dec. 16, 2010

(54) Systems And Apparatus For Transmitting Remote Control Commands Over A Communication Network

(75) Inventor: Jeremy S. Mickelsen, Denver, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies, L.L.C., Englewood, CO (US)

(21) Appl. No.: 12/483,076

(22) Filed: Jun. 11, 2009

(51) Int. Cl. G05B 11/01

(52) U.S. Cl. 340/310.11

(57) ABSTRACT

Described herein are techniques for transmitting remote control commands to a controlled device over a communication network. A user provides input to a remote control requesting to remotely operate a controlled device. A remote control command is transmitted from the remote control to the controlled device through an electrical distribution network. The controlled device receives and processes the remote control command and changes its operational state according to the command.

### BACKGROUND

Some television providers offer multiple room television receivers that are capable of receiving television signals from a content provider and distributing content to associated presentation devices in disparate locations within a structure. For example, a first television may be located in the family room of a home and a second television may be located in a bedroom of the home. A satellite television receiver may be located in the family room near the first television and may include multiple television tuners capable of receiving multiple television programs simultaneously from a content provider through an associated satellite antenna. The television receiver may then distribute separate content streams to each television. Because at least one television is located in a different room from the television receiver, it is infeasible to utilize an infrared (IR) remote control to control the television receiver when standing near the distally located television. Radio frequency (RF) remote controls have been developed that may be utilized to remotely control a television receiver from another room. However, the RF remote controls are limited by the wireless range of the remote control and the television receiver, which may mean that the user is unable to remotely control the television receiver at the location of a television receiving content from the television receiver. Many other remotely controlled devices also suffer from similar problems with the wireless range of the receiver and a remote control.

### BRIEF DESCRIPTION OF THE DRAWINGS

The same number represents the same element or same type of element in all drawings.

FIGS. 1-4 illustrate embodiments of a communication system.

FIG. 5 illustrates an embodiment of the transmitting device of FIG. 4.

FIG. 6 illustrates an embodiment of the receiving device of FIG. 4.

FIG. 7 illustrates an embodiment of a process for transmitting data from a remote control to a controlled device over a communication network.

### DETAILED DESCRIPTION

The various embodiments described herein generally provide apparatus, systems and methods which facilitate the transmission of remote control commands over a communication network to a controlled device. In at least one embodiment, the communication network is provided over an electrical distribution network. A transmitting device transmits remote control commands to the controlled device through the electrical distribution network. The controlled device receives and processes the remote control commands and changes its operational state accordingly.

In at least one embodiment, a remote control is coupled to the electrical distribution network via an electrical socket of the electrical distribution network. For example, the remote control may be a computer plugged into the electrical socket and the controlled device may be a television receiver plugged into another electrical socket of the electrical distribution network. The electrical distribution network within the structure communicatively couples the television receiver and the computer. A user may provide input requesting to remotely control the television receiver via the computer. The computer initiates transmission of a command to the controlled device through the electrical distribution network. The controlled device receives the command and changes its operational state based on the command.

In at least one embodiment, the communication network includes a receiving device that interfaces the remote control and the controlled device. For example, the remote control may be plugged into an electrical socket and the controlled device may be a television receiver located distally from the remote control. An interface device may be plugged into another electrical socket of the electrical distribution network. The interface device and the remote control are communicatively coupled through the electrical distribution network within the structure. The interface device receives a message from the remote control requesting to remotely control the television receiver. The interface device processes the message and outputs a command to the controlled device. For example, the interface device may include an IR transmitter to output IR codes operable to remotely control the television receiver. In at least one embodiment, the interface device is operable to translate the message from the remote control into a command compatible with the controlled device.

In at least one embodiment, a transmitting device is communicatively coupled to a remote control to receive input from a user and transmit the input to a controlled device. For example, a transmitting device may be communicatively coupled to the controlled device through the electrical distribution network. A user may press one or more buttons of the remote control, requesting to remotely control the controlled device. The remote control transmits data corresponding with the input to the transmitting device. In at least one embodiment, the transmitting device translates the data into a format compatible with the controlled device. The transmitting device transmits the translated data to the controlled device. The controlled device processes the data to change its operating state accordingly.

In at least one embodiment, the communication network may include multiple devices which interface with the remote control and the controlled device to communicatively couple the remote control and the controlled device together. For example, a transmitting device and a receiving device may be communicatively coupled through an electrical distribution network. The transmitting device receives input from a remote control and transmits the input to the receiving device through the electrical distribution network. The receiving device is operable to transmit the input to the controlled device. In some embodiments, the input may be translated into a different format for transmission through the electrical distribution network. For example, the remote control may output an IR code to the transmitting device. The transmitting device may then translate the IR code into an interne protocol (IP) format for transmission through the electrical distribution network. The receiving device may also be operable to translate the IP formatted data into an IR code that is outputted to the controlled device.

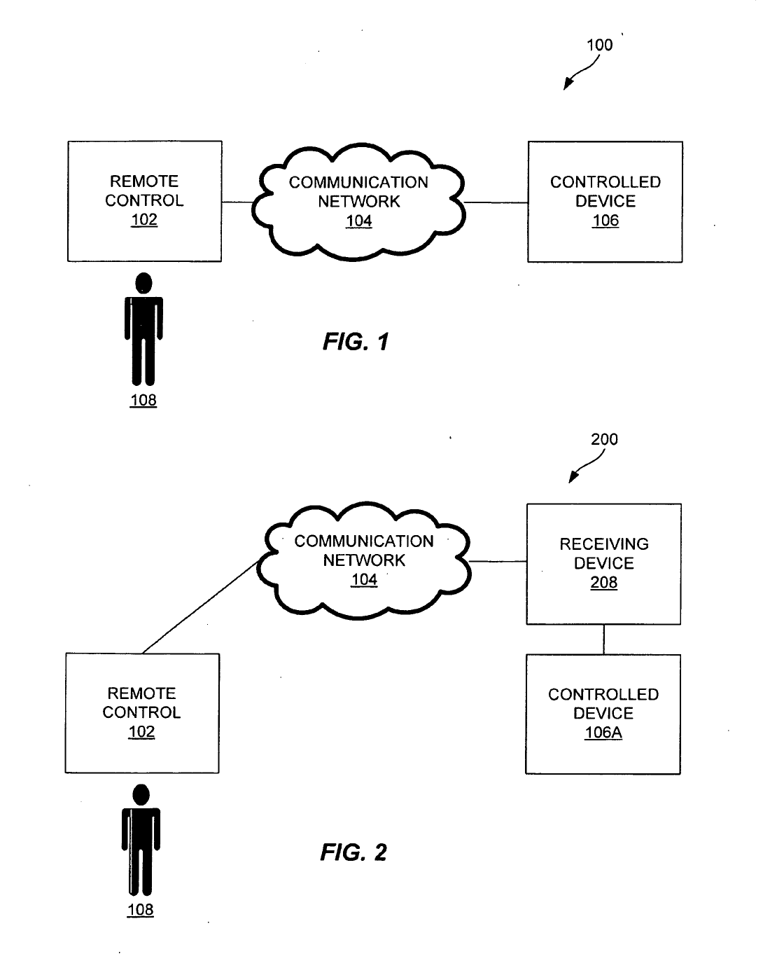

FIG. 1 illustrates an embodiment of a communication system 100. The communication system includes a remote control 102, a communication network 104 and a controlled device 106. Each of these components is discussed in greater detail below. The communication system 100 may include other elements, components or devices not illustrated for the sake of brevity.

The remote control 102 is operable to receive input from a user 108 and generate commands operable to remotely control the controlled device 106. The remote control 102 may comprise any device operable to receive input from the user 108. For example, the remote control 102 may be a handheld entertainment device remote control (e.g., a television or television receiver remote control), a mobile communication device (e.g., a mobile phone, personal digital assistant (PDA) device or the like), a personal computer, a wall mounted keypad, keyboard or touch panel display and the like. In some embodiments, the controlled device 106 may be operable to output content to a presentation device (e.g., a television, display monitor, audio receiver, speaker system or the like) and the remote control 102 may be integrated with or associated with the presentation device. For example, the remote control 102 may be buttons of a television that are configured to remotely control operations of an associated television receiver (e.g., a cable, satellite, IPTV or terrestrial television receiver) or video server.

In at least one embodiment, the remote control 102 is directly connected to the communication network 104. For example, the remote control 102 may be a laptop that is coupled to the communication network 104 through a power plug of the laptop. In at least one embodiment, the remote control 102 may be connected to the communication network 104 through an interface device, such as a wireless receiver operable to receive data from the remote control 102.

The communication network 104 is operable to communicatively couple the remote control 102 and the controlled device 106. The communication network 104 may additionally communicatively couple the remote control 102 and/or the controlled device 106 to other devices, such as other remote controls or controlled devices. In at least one embodiment, the communication network 104 is provided over an electrical distribution network. In other words, data is exchanged between the remote control 102 and the controlled device 106 over electrical power supply lines within a home. In at least one embodiment, data may be transmitted bi-directionally between the remote control 102 and the controlled device 106. In at least one embodiment, the communication network 104 may be embodied as a HomePlug communication network. However, it is to be appreciated that other types of power line communication networks may also be utilized with the teachings described herein.

The controlled device 106 may be any device capable of being remotely controlled by the remote control 102. In at least one embodiment, the controlled device 106 is a television receiver or other type of audio, video or audio/video output device operable to provide content to associated presentation devices (e.g., televisions). Other exemplary audio and video output devices include video servers, digital video disk (DVD) players, audio playback systems and the like. The controlled device 106 may transmit content to a presentation device through the communication network 104 or via a separate communication medium, such as a coaxial cable distribution network or wireless network. In at least one embodiment, the controlled device 106 may comprise a household appliance, such as a washing machine, dryer, security system, garage door, oven, stove or the like operable to receive commands from the remote control 102.

In at least one embodiment, the controlled device 106 may be directly connected to the communication network 104. For example, the controlled device 106 may be directly connected to the communication network 104 through the power plug of the controlled device 106. The controlled device 106 may also may be communicatively coupled to the communication network 104 through an interface device, e.g., through a wired or wireless connection, as described in further detail below.

To control the controlled device 106 from a remote location, the user 108 provides input to the remote control 102. The remote control 102 processes the input to generate a message for transmission to the controlled device 106. The message includes information requesting the controlled device 106 to change its operational status. The message is transmitted from the remote control 102 to the controlled device 106. The controlled device 106 processes the message and changes its operational status accordingly. For example, the controlled device 106 may change a channel of content that it is presently outputting or access a particular feature of the controlled device, such as an electronic programming guide. In at least one embodiment, the controlled device 106 is a household appliance, such as a washing machine, and the controlled device 106 shuts off responsive to the message from the remote control 102.

As described above, the controlled device 106 may interface with the communication network 104 via another apparatus. FIG. 2 illustrates an embodiment of a communication system 200. The communication system 200 includes a remote control 102, a communication network 104, a controlled device 106A and a receiving device 208. Each of these components is discussed in greater detail below and the discussion of components common to FIG. 1 is omitted herein. The communication system 200 may include other components elements or devices not illustrated for the sake of brevity.

The receiving device 208 is communicatively coupled to the remote control 102 via the communication network 104. For example, the receiving device 208 may be plugged into a socket of an electrical distribution network forming the communication network 104. The receiving device 208 is further communicatively coupled to the controlled device 106A. The receiving device 208 may be communicatively coupled to the controlled device 106A through any type of wired or wireless connection. For example, the receiving device 208 may be coupled to the controlled device 106A through a USB, serial cable, IEEE 1394 cable, Ethernet cable or the like. In at least one embodiment, the receiving device 208 is wirelessly connected to the controlled device 106A, e.g., through an infrared or RF communication link. In some embodiments, the wireless connection may be bidirectional.

To control the controlled device 106A from a remote location, the user 108 provides input to the remote control 102. The remote control 102 processes the input to generate a message for transmission to the receiving device 208. The message includes information requesting the controlled device 106A to change its operational status. The message is transmitted from the remote control 102 to the receiving device 208. The receiving device 208 processes the message and outputs a command to the controlled device 106A. In at least one embodiment, the receiving device 208 is operable to translate the message into a format compatible with the controlled device. For example, the message may be transmitted in an IP format and the controlled device 106A may be operable to receive input in the form of IR codes. Thus, the receiving device 208 may translate the message into a corresponding IR code and output the IR code to the controlled device 106A. The controlled device 106A processes the command and changes its operational status accordingly.

As described above, the remote control 102 may interface with the communication network 104 via another apparatus. FIG. 3 illustrates an embodiment of a communication system 300. The communication system 300 includes a remote control 102A, a communication network 104, a controlled device 106 and a transmitting device 310. Each of these components is discussed in greater detail below and the discussion of components common to FIG. 1 is omitted herein. The communication system 300 may include other components, elements or devices not illustrated for the sake of brevity.

The transmitting device 310 is operable to communicatively couple the remote control 102A to the communication network 104. The transmitting device 310 is further operable to communicate with the controlled device 106 through the communication network 104. The remote control 102A and the transmitting device 310 may be communicatively coupled through any type of wired or wireless communication link. In at least one embodiment, the remote control 102A is operable to communicate with the transmitting device 310 through an IR communication link, e.g., using IR codes. In another embodiment, the remote control 102A is operable to communicate with the transmitting device 310 through an RF communication link, such as WiFi, Bluetooth, ZigBee and the like. In at least one embodiment, the remote control 102A is communicatively coupled to the transmitting device 310 through a cable, such as an Ethernet, USB, IEEE 1394 or serial cable and the like.

The transmitting device 310 receives input from the remote control 102A requesting to remotely operate the controlled device 106. For example, the user 108 may request to change a channel being output by the controlled device 106. In at least one embodiment, the transmitting device 310 receives the input and translates the input into a format compatible for transmission across the communication network 104. For example, an IR code output by the remote control 102A may be translated into an IP formatted message for transmission to the controlled device 106. The transmitting device 310 initiates transmission of a message to the controlled device 106, the message requesting the controlled device 106 to change its operating status. The controlled device 106 receives and processes the message and changes its operational state accordingly.

In at least one embodiment, a remote control 102 (see FIG. 1) and a controlled device (see FIG. 1) may both communicatively couple to the communication network 104 through interface devices. FIG. 4 illustrates an embodiment of a communication system 400. The communication system 400 includes a remote control 102B, a transmitting device 310A, a receiving device 208A, a controlled device 106B and a communication network 104. Each of these components is discussed in greater detail below. The communication system 400 may include other components, elements or devices not illustrated for the sake of brevity.

The transmitting device 310A is operable to interface the remote control 102B with the communication network 104. The transmitting device 310 may be communicatively coupled to the remote control 102B through any type of wireless or wired connection. The transmitting device 310A is further communicatively coupled to the receiving device 208A through the communication network 104.

A user 108 provides input to the remote control 102B and the remote control 102B outputs data to the transmitting device 310A. The transmitting device 310 receives the data, performs appropriate processing to format the input for transmission across the communication network 104 and initiates transmission of a message to the receiving device 208A. If appropriate, the input is translated into a format compatible for reception by the receiving device 208A.

The receiving device 208A is operable to interface the controlled device 106B with the communication network 104. More particularly, the receiving device 208A receives data from the transmitting device 310A and outputs the data to the controlled device 106B. If appropriate, the receiving device 208A translates the data into a format compatible with the controlled device 106B. For example, an IP formatted message may be translated into an IR code that is output by the receiving device 208A to the controlled device 106B. As described above, the controlled device 106B processes the data received from the receiving device 106B to change its operational state responsive to the command contained within the data.

Advantageously, the communication system 400 allows for the extension of the range of the remote control 102B. For example, an IR remote control 102B may be utilized within a location that is not within line of sight to the controlled device 106B, e.g., within another room. The communication system 400 may also be utilized to extend the range of other types of wireless remote controls, such as UHF, Bluetooth, ZigBee and the like which may otherwise be limited by the distance between the remote control 102B and the controlled device 106B or obstacles located between the two devices.

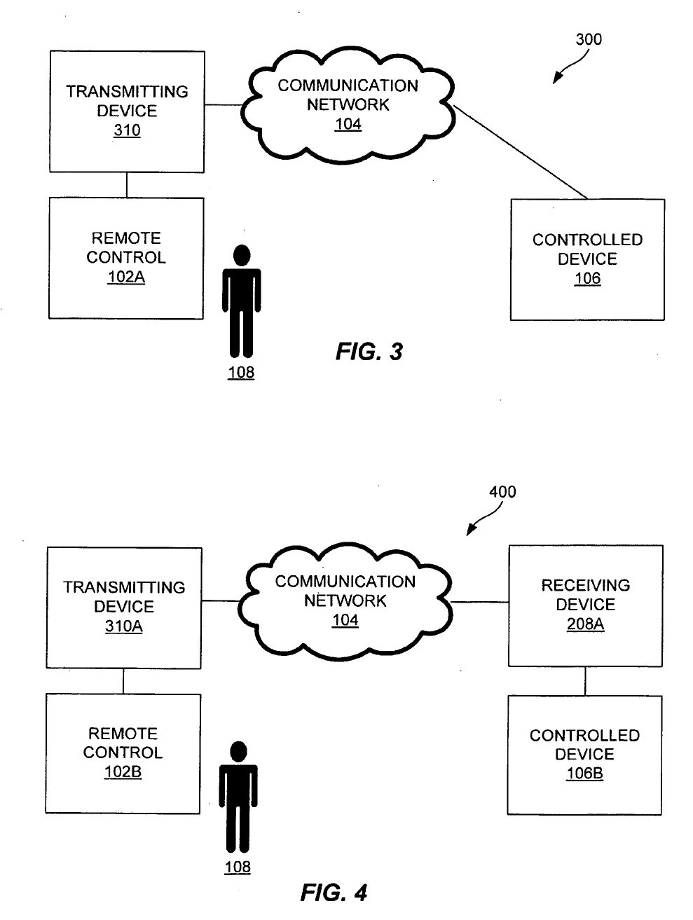

FIG. 5 illustrates an embodiment of the transmitting device 310B of FIG. 4. FIG. 5 will be discussed in reference to the communication system 400 illustrated in FIG. 4. The transmitting device 310B of FIG. 5 includes an electrical connector 502, a communication module 504, a wireless receiver 506 and control logic 508. Each of these components is discussed in greater detail below. The transmitting device 310B may include other components, elements or devices not illustrated for the sake of brevity.

The electrical connector 502 includes a plurality of prongs 510 and 512 that couple to a socket of an electrical distribution network. More particularly, the prongs 510 and 512 receive electrical current from the socket that powers the transmitting device 310B. At the same time, the prongs 510 and 512 communicatively couple to the communication network 104 (see FIG. 4) through the socket. While the transmitting device 310A is illustrated as having two prongs 510 and 512, it is to be appreciated that any number of prongs in any type of configuration may be utilized.

The communication module 504 is configured to receive/transmit data with other devices of the communication network 104 (see FIG. 1). The communication module 504 modulates data into an RF signal for transmission to other devices (e.g., the receiving device 208A (see FIG. 4)) and receives similar RF signals from the receiving device 208A. The communication module 504 is further configured to translate these signals into data appropriate for use by the control logic 508 and to translate signals from the control logic 508 for transmission across the communications network 104. The communication module 504 may communicate with other devices of the communication network 104 using any type of protocol appropriate for transmitting data through the electrical distribution network. In at least one embodiment, the communication module 504 utilizes the HomePlug protocol to communicate data over the communication network 104 (see FIG. 4). In other embodiments, the communication module 504 may utilize other protocols, such as DS2.

The wireless receiver 506 is operable to wirelessly receive user input from the remote control 102B (see FIG. 4). The wireless receiver 506 may communicate with the remote control 102 utilizing any type of IR or RF communication link. For example, the wireless receiver 506 may be an IR receiver, WiFi receiver, Bluetooth receiver, ZigBee receiver, UHF receiver or the like. In at least one embodiment, the wireless receiver 506 receives a key code from the remote control 102B (see FIG. 4), and responsively provides the key code to the control logic 508. In at least one embodiment, the wireless receiver 506 is a transceiver that is operable to bi-directionally communicate with the remote control 102B (see FIG. 4). For example, the wireless receiver 506 may be operable to transmit data to the remote control 102B (see FIG. 4), such as IR database code updates, firmware updates and the like.

The control logic 508 is operable for controlling the operation of the transmitting device 310B. The control logic 508 may be a single device or multiple devices operable to control the operation of the transmitting device 310B. The control logic 508 is operable to receive the user input from the wireless receiver 506 and generate a command for transmission across the communication network 104. The control logic 508 is further operable to initiate transmission of the command to the receiving device 208B (see FIG. 4) through the communication module 504. In at least one embodiment, the control logic 508 may be operable to translate the user input received from the remote control 102B (see FIG. 4) into a format compatible with the receiving device 208A and/or the controlled device 106, e.g., from a UHF remote control code to an IR code or from an IR code to a IP formatted message.

As described above, in some embodiments, a transmitting device may be communicatively coupled directly to a controlled device through a communication network. In at least one embodiment, the control logic 508 may alternatively initiate transmission of the command to a controlled device through the communication module 504. The input may be formatted as appropriate by the control logic 508 for transmission to the controlled device.

If the remote control 102B (see FIG. 4) is operable to receive data from the controlled device 106B or other devices communicatively coupled to the communication network 104, then the communication module 504 may receive data from the devices. The control logic 508 is operable to process the data received by the communication module 504 through the communication network 104 and initiate transmission of the data to the remote control 102B (see FIG. 4) through the wireless receiver 506, (e.g., a wireless transceiver). Thus, the remote control 102B (see FIG. 4) may receive data from the controlled device 106B even when the remote control 102B is out of wireless range of the controlled device 106B.

Those of ordinary skill in the art will appreciate that the various functional elements 504 through 508 shown as operable within the transmitting device 310B may be combined into fewer discrete elements or may be broken up into a larger number of discrete functional elements as a matter of design choice. For example, the functional units 504, 506, and 508 may be co-located with each other into a single component such as an IC. Thus, the particular functional decomposition.suggested by FIG. 5 is intended merely as exemplary of one possible functional decomposition of elements within the transmitting device 310B.

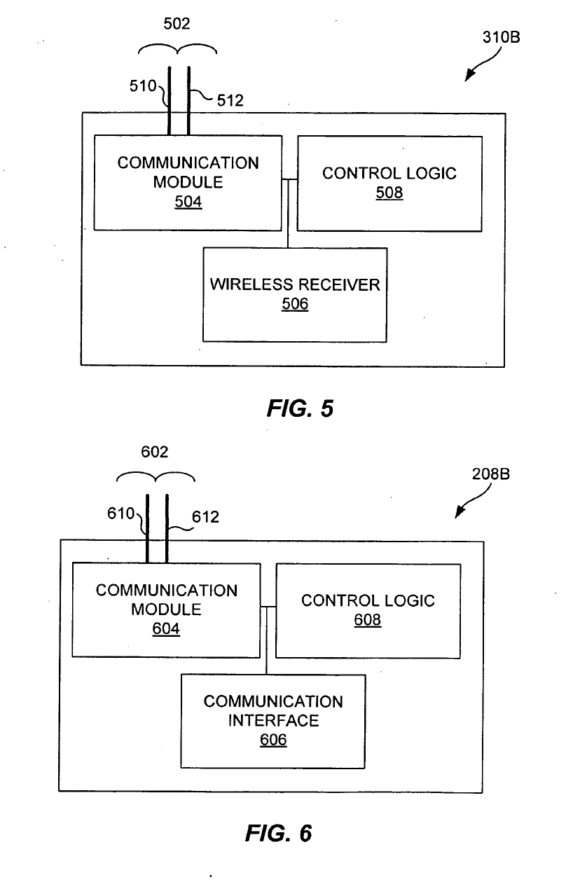

FIG. 6 illustrates an embodiment of the receiving device 208B of FIG. 4. FIG. 6 will be discussed in reference to the communication system 400 illustrated in FIG. 4. The receiving device 208B of FIG. 6 includes an electrical connector 602, a communication module 604, a communication interface 606 and control logic 608. Each of these components is discussed in greater detail below. The receiving device 208B may include other components, elements or devices not illustrated for the sake of brevity.

The electrical connector 602 includes a plurality of prongs 610 and 612 that couple to a socket of an electrical distribution network. The electrical connector 602 may be similar to the electrical connector 502 of FIG. 5 and further discussion is omitted herein for the sake of brevity. The communication module 604 is configured to exchange data with other devices of the communication network 104 (see FIG. 4), such as the transmitting device 310A. The communication module 604 may be similar to the communication module 504 of FIG. 5 and further discussion is omitted herein for the sake of brevity.

The communication interface 606 communicatively couples the controlled device 106B to the communication network 104. More particularly, the communication interface 606 is operable to transmit data received from other devices to the controlled device 106B (see FIG. 4). The communication interface 606 may be any type of wireless or wired interface depending on desired design criteria. For example, the communication interface 606 may be an IR transmitter, RF transmitter (e.g., UHF, Bluetooth, WiFi, Zigbee and the like) operable to wirelessly transmit data to the controlled device 106B. In other embodiments, the communication interface 606 may be a wired connection that couples to the controlled device 106B (see FIG. 4), such as USB, Ethernet, serial cable, IEEE 1394 and the like. In at least one embodiment, the communication interface 606 is operable to bi-directionally communicate with the controlled device.

The control logic 608 is operable for controlling the operation of the receiving device 208B. The control logic 608 may be a single device or multiple devices operable to control the operation of the receiving device 208B. The control logic 608 is operable to receive a message from the communication module 604 and extract a command for the controlled device 106B (see FIG. 4). The control logic 508 is further operable to initiate transmission of the command to the controlled device 106B (see FIG. 4) through the communication interface 606. In at least one embodiment, the control logic 608 may be operable to translate the command received from another device to a format compatible with the controlled device 106B. The controlled device 106B receives the command and changes its operational status according to the input from the user 108 (see FIG. 4).

Those of ordinary skill in the art will appreciate that the various functional elements 604 through 608 shown as operable within the receiving device 208B may be combined into fewer discrete elements or may be broken up into a larger number of discrete functional elements as a matter of design choice. For example, the functional units 604, 606, and 608 may be co-located with each other into a single component such as an IC. Thus, the particular functional decomposition suggested by FIG. 5 is intended merely as exemplary of one possible functional decomposition of elements within the receiving device 208B.

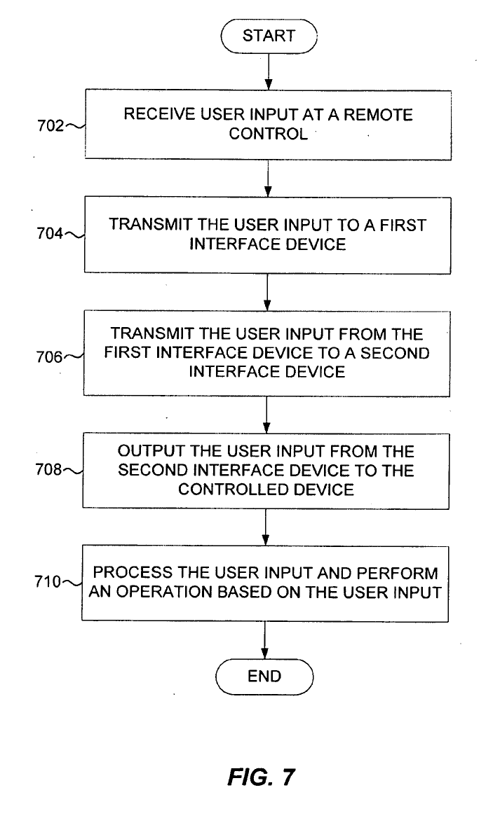

FIG. 7 illustrates an embodiment of a process for transmitting data from a remote control to a controlled device over a communication network. The process of FIG. 7 may include other operations not illustrated for the sake of brevity.

The process includes receiving user input at a remote control (operation 702). The process further includes transmitting the user input to a first interface device (operation 704). The process further includes transmitting the user input from the first interface device to a second interface device through an electrical distribution network (operation 706). The process further includes outputting the user input from the second interface device to the controlled device (operation 708). The process further includes processing the user input at the controlled device and performing an operation based on the user input (operation 710).

Although specific embodiments were described herein, the scope of the invention is not limited to those specific embodiments. The scope of the invention is defined by the following claims and any equivalents therein.

I claim:

1. An apparatus comprising:
an electrical connector that connects to a socket of an electrical distribution network, the electrical distribution network communicatively coupling the apparatus to a controlled device;
a communication module coupled to the electrical connector that transmits data to the controlled device through the electrical distribution network;
a wireless receiver that receives user input from a remote control; and
control logic communicatively coupled to the wireless receiver and the communication module, the control logic operable to process the user input to generate a command for the controlled device and initiate transmission of the command to the controlled device through the communication module.

2. The apparatus of claim 1, wherein the wireless receiver comprises an infrared receiver.

3. The apparatus of claim 1, wherein the wireless receiver comprises a radio frequency receiver.

4. The apparatus of claim 1, wherein the communication module is further operable to receive data from the controlled device through the electrical distribution network and wherein the wireless receiver further comprises a wireless transceiver operable to transmit the received data to the remote control.

5. The apparatus of claim 1, wherein the controlled device comprises a television receiver and wherein the apparatus comprises a presentation device operable to receive content from the television receiver.

6. A receiving apparatus comprising:
an electrical connector that connects to a socket of an electrical distribution network, the electrical distribution network communicatively coupling the receiving apparatus to a transmitting apparatus;
a communication module coupled to the electrical connector that receives a message from the transmitting apparatus through the electrical distribution network, the message requesting to remotely operate the controlled device;
a communication interface communicatively coupled to a controlled device; and
control logic communicatively coupled to the communication interface and the communication module, the control logic operable to process the message to generate a command for the controlled device and initiate transmission of the command to the controlled device through the communication interface.

7. The receiving apparatus of claim 6, wherein the communication interface comprises an infrared transmitter.

8. The receiving apparatus of claim 6, wherein the communication interface comprises a radio frequency transmitter.

9. The receiving apparatus of claim 6, wherein the communication interface comprises a wired connection to the controlled device.

10. The receiving apparatus of claim 6, wherein the receiving device is integrated with the controlled device.

11. The receiving apparatus of claim 6, wherein the receiving apparatus comprises a television receiver.

12. The receiving apparatus of claim 11, wherein the transmitting apparatus comprises a presentation device operable to receive content from the television receiver.

13. The receiving apparatus of claim 6, wherein the transmitting apparatus is operable to receive user input from a remote control associated with the controlled device and format the user input into a format compatible with the communication module.

14. A system comprising:
a transmitting apparatus comprising:
a first electrical connector that connects to a first socket of an electrical distribution network;
a first communication module coupled to the electrical connector;
an input interface that receives user input requesting to remotely operate a controlled device;
first control logic communicatively coupled to the wireless receiver and the first communication module, the first control logic operable to process the user input to generate a message and initiate transmission of the message through the first communication module; and
a receiving apparatus comprising:
a second electrical connector that connects to a second socket of the electrical distribution network, the electrical distribution network communicatively coupling the receiving apparatus and the transmitting apparatus;
a second communication module coupled to the second electrical connector that receives the message from the first communication module through the electrical distribution network;
a communication interface communicatively coupled to the controlled device; and
second control logic communicatively coupled to the second communication module and the communication interface, the second control logic operable to process the message to generate a command for the controlled device and initiate transmission of the command to the controlled device through the communication interface.

15. The system of claim 14, wherein the input interface comprises a wireless receiver that receives the user input from a remote control.

16. The system of claim 15, wherein the wireless receiver comprises an infrared receiver.

17. The system of claim 15, wherein the wireless receiver comprises a radio frequency receiver.

18. The system of claim 14, wherein the transmitting apparatus is integrated within a computer.

19. The system of claim 14, wherein the communication interface comprises an infrared transmitter.

20. The system of claim 14, wherein the wireless receiver comprises a radio frequency transmitter.
